(19) United States
(12) Patent Application Publication
(10) Pub. No.: US 2022/0333476 A1
(43) Pub. Date: Oct. 20, 2022

(54) Self-Powered Downhole Electrolysis Tool

(71) Applicants: Alex M Hemb, Kamas, UT (US); Kevin J Sylla, Woodland Hills, CA (US); Bruno P Allaire, Santa Fe, NM (US)

(72) Inventors: Alex M Hemb, Kamas, UT (US); Kevin J Sylla, Woodland Hills, CA (US); Bruno P Allaire, Santa Fe, NM (US)

(21) Appl. No.: 17/659,511

(22) Filed: Apr. 18, 2022

Related U.S. Application Data
(60) Provisional application No. 63/201,189, filed on Apr. 16, 2021.

(51) Int. Cl. E21B 43/38; E21B 41/00; F03B 13/08; C25B 1/04; C25B 9/17; C25B 9/65

(52) U.S. Cl. CPC E21B 43/38; E21B 41/0085; F03B 13/08; C25B 1/04; C25B 9/17; C25B 9/65; F05B 2220/32; F05B 2220/61

(57) ABSTRACT

A downhole power generation system uses the inherent downhole energy in the well to operate an electrolysis system that creates hydrogen and oxygen gas. A turbine can be driven by movement in the well, which can drive a generator to create the electrolysis. Other embodiments can use other ways of obtaining energy from the well including the piezoelectric device or heat exchanger.

This application claims priority from provisional application No. 63/201,189, the entire contents of which are herewith incorporated by reference.

### BACKGROUND

Wells are often used for various purposes, including supply of water for home uses, irrigation, and industries.

Once a well is dug, it can be used for many years. Sometimes the operations that are taken in a well require power.

### SUMMARY OF THE INVENTION

The inventor recognized that it is desirable to produce hydrogen and oxygen gas inside of a well, or “downhole”, using an electrochemical apparatus that operates based on the inherent downhole energy.

The present device describes a tubular downhole electrolysis device that uses a turbine and generator to create energy from the inherent downhole energy.

In an embodiment, the device has an anode and a cathode that is powered from the generator. A packer device is configured to collect the gases produced by the downhole electrolysis. By doing this, the device uses the downhole energy, e.g. the circulation of water or the geothermal energy, to continuously produce power and hence continually create both hydrogen and oxygen gas using the electrolysis process.

Another embodiment can use an external power source such as a solar panel situated on the surface.

Another embodiment uses a piezoelectric device

The present device describes a tubular downhole device that uses either a turbine and generator or heat exchanger or Piezoelectric circuit to create energy from the inherent downhole energy. A piezoelectric device or a heat exchanger will be used in the applications where the well is static or no circulation of fluids take place.

### BRIEF DESCRIPTION OF THE DRAWINGS

In the Drawings:

the FIG. 1 shows an embodiment of the invention using a turbine driven generator;

FIG. 2 shows an embodiment using a heat exchanger;

FIG. 3 shows using solar; and

FIG. 4 show using a piezoelectric device.

### DETAILED DESCRIPTION

The present application describes a system and method for producing hydrogen and oxygen gas in a downhole environment.

An embodiment uses a downhole electrical generation to power a downhole electrochemical apparatus. The electrochemical apparatus is introduced into a downhole environment that has an inherent energy source, e.g. a geothermal or into another well, such as an abandoned nonproducing hydrocarbon wellbore.

An embodiment uses a turbine 100, connected to a generator 105, and inverter 110, to produce electricity that is connected to an anode 120, and a cathode 125. All of the parts are assembled in a cylindrical and modular configuration. The cylindrical housing 99 includes an outer wall 130, and an inner wall 135. There is an inner hollow space for circulating fluid flow from inside the well along the vertical axis.

The inner hollow space contains an anode 120 and cathode 125.

In this embodiment, the water that inherently circulates inside the well bore is introduced into the interior of the housing 99. This water flow caused by the circulation causes rotation of the turbine 100 which creates energy from the generator 105 and inverter 110. The power from the inverter is used to power the anode and cathode, thus creating hydrogen and oxygen bubbles by hydrolysis. This “product gas” includes hydrogen gas and oxygen gas.

The product gas bubbles travel up the annular space between the electrochemical apparatus and the inside diameter of the wellbore defined by the casing layer. These travel as gas bubbles 140 travel up to the top, where they are packaged by a completion packer 150 which is attached to production tubing thus eliminating any rogue product gas from traveling uncontrolled. Gases collected on the surface through a wellhead and distribution pipe.

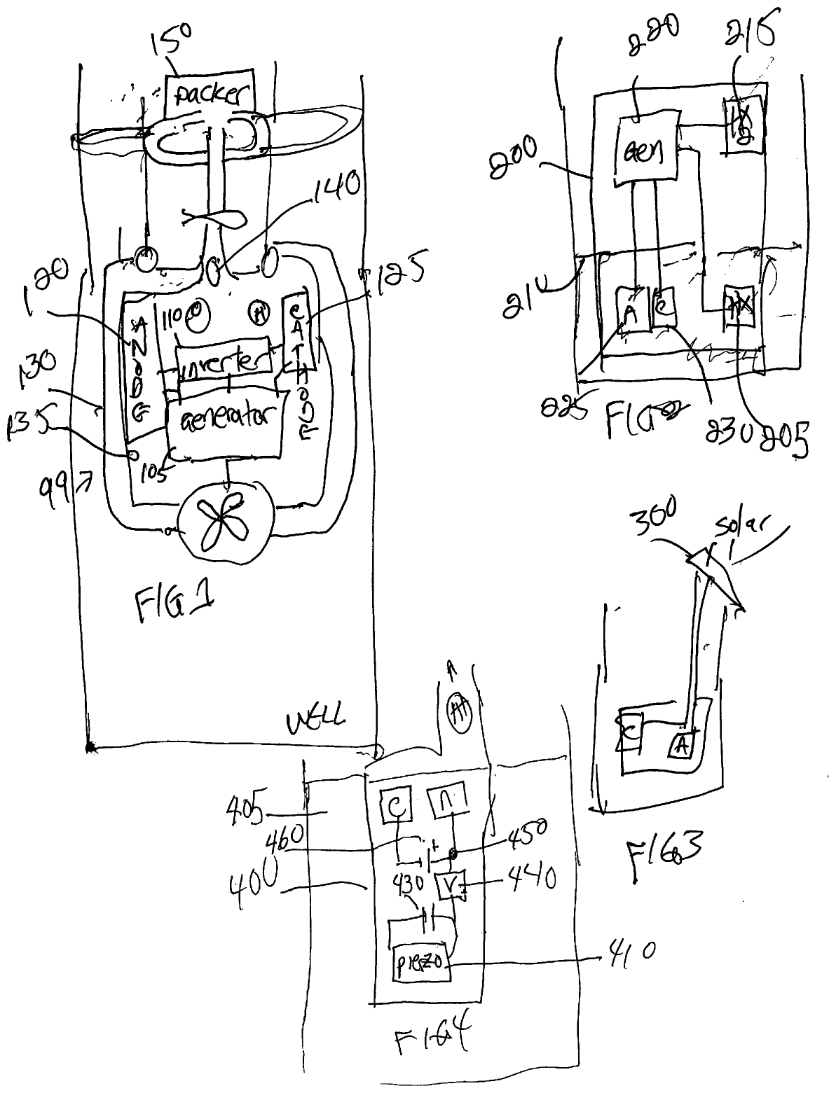

In alternative embodiment shown in FIG. 2, the energy is created by heat exchangers in the well that produce the power based on the temperature difference in the well. The housing 200 is located in the well with the first of the heat exchangers 205 under the waterline 210, and a second of the heat exchangers 215 over the waterline 210. The temperature difference between the heat exchanger in the water 205 and heat exchanger above the water 215 causes the generator 222 create electricity to the anode 225 and cathode 230 which creates the gas bubbles as in the first embodiment. The embodiment of FIG. 2, as well as all the other embodiments described herein, are intended to be used with a similar kind of completion packer for receiving the hydrolyzed gas.

This can be used to carry out electrolysis in a well that does not have circulating water, for example in non-geothermal wells. Static depleted hydrocarbon wells for example can use this alternative method.

Another embodiment as in FIG. 3, can use an external power source, in one embodiment a solar panel 300 situated on the surface to provide power to the downhole electrolyzer. This could be used for example in a wellbore that does not have sufficient heat or energy downhole to power a heat exchanger.

Another embodiment, shown in FIG. 4, uses a piezoelectric circuit for the power generation. In this embodiment, the tubular housing 400 is placed under the water level 405 in the well. The piezoelectric device 410 can be inside a watertight sleeve, or can be a waterproof material.

The piezoelectric device is located in a location to take advantage of the downhole temperature and pressure. In one embodiment, for example, a portion of the device is maintained underwater and a portion maintained over the water to take advantage of a difference in temperature and pressure.

The piezoelectric material 410 produces voltage due to the downhole pressure and temperature applied on said material. The piezoelectric material is connected to a capacitor 430. On the output side of the capacitor, a voltage regulator device 440, which can be simply a resistor, or can include a voltage regulator chip or a Zener diode, maintains a constant output voltage 450. This output constant voltage feeds a downhole rechargeable battery 460. The output from the battery 460 supplies a downhole electrolyzer device, shown as anode and cathode. Depending on the electrolysis voltage requirement, more or fewer Piezoelectric devices can be added to the power generation segment of this downhole device.

Downhole energy can also be brought to surface to power other devices such as an oil production unit in an oil field, if so desired. In another embodiment, a well that is not producing oil can be converted to a power source to power for example, the pumping unit in a well that is producing oil.

The downhole power generation can also be used on surface to power surface electrolysis, if a specific application calls for this solution.

Hence, alternate embodiments allow the heat exchanger to be either downhole or located on the surface and connected to a solar panel providing power to the downhole electrolyzer.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An electrolysis device for use downhole in a well, comprising:
a tubular shaped device, having a tubular shaped housing, including a tubular shaped inner cavity;
a power generation device, inside said housing, and creating power;
an anode electrode, and a cathode electrode, both inside said housing and in contact with water in the well, and both said anode electrode and said cathode electrode receiving power created by the power generation device and creating hydrogen gas by hydrolyzing the water in the well; and
a packer connection, receiving gas created by the anode and the cathode; and
a gas packer, at a top of this pipe, packing the hydrogen gas created by the anode and the cathode.

2. The device as in claim 1, wherein the power generation device generates power using forces within the well.

3. The device as in claim 2, wherein the power generation device includes a turbine driven from flows within the well, and a generator, which creates electricity based on movement of the turbine.

4. The device as in claim 2, wherein the housing is open to receive water within the well, and the power generation device includes a turbine driven by water forces within the well, and the power generation device includes a generator, the turbine driving the generator, and the generator producing electricity that is connected to the anode electrode and the cathode electrode, to electrolyze the water in the well.

5. The device as in claim 2, wherein the power generation device creates power using a temperature difference between water in the well and an area above the water in the well using heat exchangers to create electricity to drive the anode cathode electrodes.

6. The device as in claim 2, wherein the power generation device includes a piezoelectric device is located in a location to take advantage of the downhole temperature and pressure to create electricity.

7. The device as in claim 6, where a portion of the piezoelectric device is maintained underwater and a portion maintained over the water to take advantage of a difference in temperature and pressure.

8. The device as in claim 6, where the piezoelectric device is connected to a capacitor, a voltage regulator device, and a downhole rechargeable battery that connects to the anode electrode and cathode electrode.
